(19) United States
(12) Patent Application Publication
(10) Pub. No.: US 2008/0236945 A1
(43) Pub. Date: Oct. 2, 2008

(54) ADJUSTABLE-HEIGHT SAWHORSE

(76) Inventors: Jean-Guy LAROUCHE, Normandin (CA); Charles VEILLEUX, Jonquiere (CA)

Correspondence Address: OGILVY RENAULT LLP, 1981 MCGILL COLLEGE AVENUE, SUITE 1600, MONTREAL, QC, H3A2Y3, CA

(21) Appl. No.: 12/058,869

(22) Filed: Mar. 31, 2008

Related U.S. Application Data
(60) Provisional application No. 60/909,560, filed on Apr. 2, 2007.

(51) Int. Cl. B25H 1/06

(52) U.S. Cl. 182/153

(57) ABSTRACT

The sawhorse has a body and an adjustable height horizontal load supporting beam vertically movable relatively to the body. A vertically extendible member can be used between the load-supporting beam and the body to adjust the vertical position of the load-supporting beam relative to the body, with an actuator to operate the vertically extendible member. The sawhorse can have a mechanism allowing to adjust the height of the load supporting beam while the sawhorse is supporting a load. An adjustable height unit for use assembled to a sawhorse body is also described.

### CROSS-REFERENCE TO RELATED APPLICATION

This application claims priority of U.S. provisional application No. 60/909,560, entitled “Adjustable-Height Sawhorse”, filed Apr. 2, 2007 by applicant, the contents of which are hereby incorporated by reference

### BACKGROUND

Sawhorses are commonly used in the woodworking industry to support work pieces. In the construction industry, they are typically referred to as trestles and are used to support scaffolds or the like. Sawhorses typically have a horizontal beam supported at each end by a pair of splayed legs. The horizontal beam has an upper work surface. Sawhorses are typically used in pairs, and work pieces or scaffolds can be supported by the work surfaces of both sawhorses.

Some former sawhorses provided an adjustable height work surface, but suffered from the drawback that the height of the work surface could not be adjusted while the work piece was positioned thereon. Much time was lost when removing the work piece from the work surface to adjust the height thereof. Further, some woodworking tasks require the work piece to be leveled. Leveling the work piece could take some time with such sawhorses because several trials and errors were required in adjusting the height of one of the two sawhorses, until both work surfaces were horizontally aligned.

As it can be seen therefore, although some former sawhorses were satisfactory to a certain degree, there remained room for improvements.

### SUMMARY

In accordance with one aspect, there is provided a sawhorse having a body and an adjustable height horizontal load supporting beam vertically movable relatively to the body, characterized in that the sawhorse has a mechanism allowing to adjust the height of the load supporting beam while the sawhorse is supporting a load.

In accordance with another aspect, there is provided a sawhorse comprising a body, a horizontal load-supporting beam, at least one vertically extendible member positioned between the load-supporting beam and the body and operable to adjust the vertical position of the load-supporting beam relative to the body, and an actuator to operate the at least one vertically extendible member.

In one embodiment, the at least one vertically extendible member includes: two reciprocal lower members having respective adjacent lower ends each pivotally mounted to the body, and respective spaced apart upper ends; two reciprocal upper members having respective adjacent upper ends each pivotally mounted to the load-supporting beam, and respective spaced apart lower ends; a first and a second connectors, each connector being pivotally mounted to both a corresponding lower member upper end and a corresponding upper member lower end, and having a bore threaded oppositely to the bore of the other connector; and a rod having a first portion threaded to mate with the first connector, and a second portion threaded to mate with the second connector, the rod being threadingly engaged through both the first and the second connectors and being rotatable about its axis to adjust the spacing between the connectors, thereby adjusting the vertical position of the load-supporting beam.

The sawhorse can have two or more longitudinally adjacent vertically extendible members interconnected by a common rod.

In accordance with another aspect, there is provided an adjustable-height unit for use on a sawhorse body, the adjustable-height unit comprising: a load-supporting beam, at least one extendible member connected to the load-supporting beam and having a sawhorse body attachment configured and adapted for fastening the adjustable-height unit to the sawhorse body opposite the load-supporting beam, the at least one extendible member having two reciprocal elongated members each oppositely slanted, and each having a first end opposite a second end, the first end of both elongated members being pivotally mounted about a transversal axis in a manner that the second ends of the elongated members are reciprocally pivotable about the first ends in a common plane, thereby raising or lowering the load-supporting beam, respectively, when in use fastened on a sawhorse body.

### DESCRIPTION OF THE FIGURES

In the appended Figs.:

FIG. 1 is a perspective view of a first example of an improved sawhorse;

FIG. 2 is a perspective view, enlarged, showing the reciprocation gears of the sawhorse of FIG. 1;

FIG. 3 is a perspective view showing an alternate embodiment to the sawhorse of FIG. 1; and

FIG. 4 is a perspective view of another example of an improved sawhorse.

### DETAILED DESCRIPTION

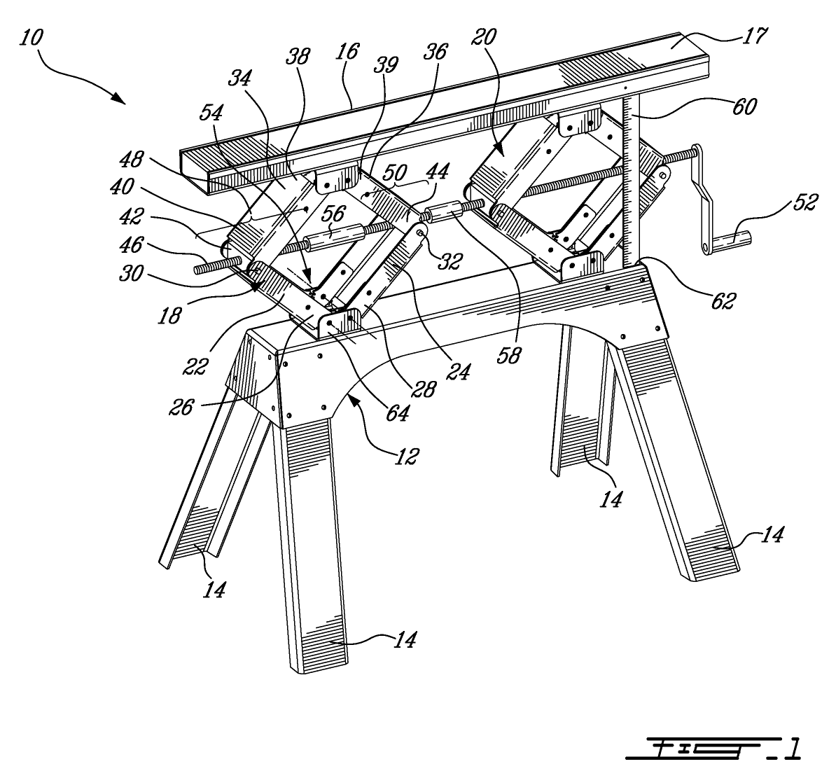

FIG. 1 shows a first example of an improved sawhorse 10. The sawhorse 10 has a body 12 having a pair of splayed support legs 14 at each end thereof. The sawhorse 10 also has an elongated load-supporting beam 16 oriented horizontally, and mounted to the body 12 via two vertically extendible members 18, 20. In this example, the load-supporting beam 16 is C-shaped with rubber tips, and has an optional wood board 17 positioned therein. The vertically extendible members 18, 20 are similar, and therefore only one will be described in detail.

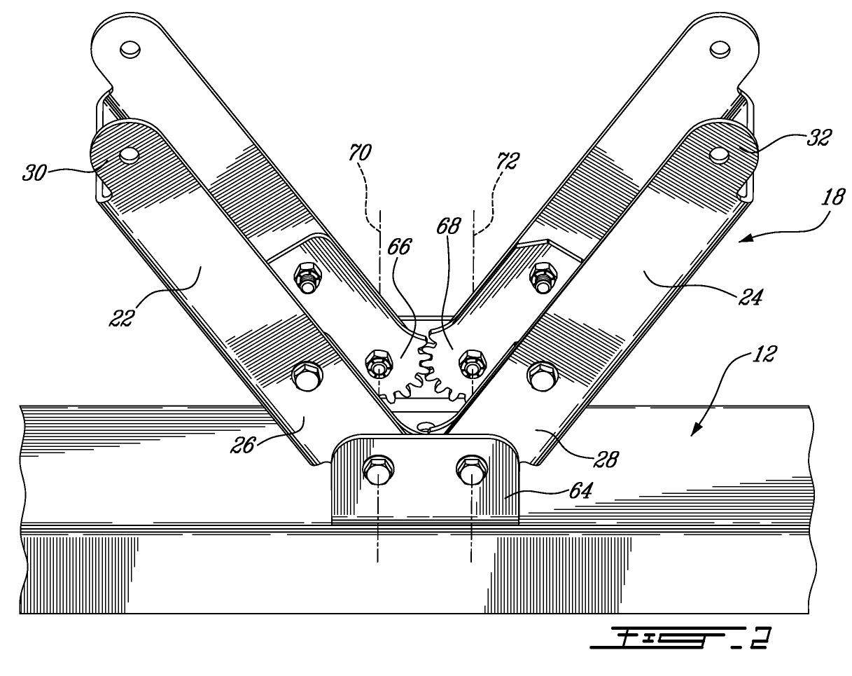

The vertically extendible member 18 has two reciprocal lower members 22, 24. Each one of the lower members 22, 24 has a corresponding lower end 26, 28 pivotally mounted to the body 12. The lower ends 26, 28 of the first lower member 22 and the second lower member 24 are adjacent to one another and are meshed to one another around two respective, adjacent pivoting axes, as will be described below in reference to FIG. 2. The upper ends 30, 32 of the lower members 22, 24 extend upwardly from the body 12 in opposite directions. The lower members 22, 24 are reciprocal in the sense that when the load supporting beam 16 is raised or lowered, the upper ends 30, 32 of the lower members 22, 24 are both pivoted closer or farther away from each other, respectively, while the lower ends 26, 28 are not displaced, i.e. the lower members 22, 24 are simultaneously pivoted by an equal but opposite angle around their base. The vertically extendible member 18 also has two reciprocal upper members 34, 36. The upper members 34, 36 each have an upper end 38, 39 pivotally mounted to the load-supporting beam 16, and a lower end 40, 44.

The vertically extendible member 18 also has a first connector 42 pivotally mounted to both the lower end 40 of the first upper member 34 and the upper end 30 of the first lower member 22, and a second connector (not shown) pivotally connected to both the lower end 44 of the second upper member 36 and the upper end 32 of the second lower member 24. The first connector 42 has a bore with a first thread direction, and the second connector has a bore with a thread in a second angular direction, opposite the first angular direction. A rod 46 is threadably engaged through the bores of the first connector 42 and the second connector 44. The rod 46 has a first portion 48 threaded in a first angular direction to mate with the threaded bore of the first connector 42. The rod 46 also has a second portion 50 threaded in a second, opposite angular direction, to mate with the threaded bore in the second connector 44, i.e. the thread in the first portion 48 of the rod 46 is counterclockwise whereas the thread in the second portion 50 is clockwise, or vice-versa. Henceforth, when the rod 46 is rotated in a given angular direction, the first connector 42 and the second connector 44 either travel along the rod 46 toward one another or away from one another, depending on the direction of rotation of the rod 46. As the connectors 42, 44 are moved toward one another, or apart from one another, the load-supporting beam 16 is raised or lowered, respectively by the imparted pivoting of the lower members 22, 24 and upper members 42, 44.

In this example, both vertically extendible members 18, 20 are positioned adjacent one another between the body 12 and the beam 16, and the rod 46 extends through both. The rod 46 can be rotated using the handle 52, which is the actuator of the vertically extendible member 18 in this embodiment. This configuration allows to precisely adjust the height of the load-supporting beam 16 by rotating the handle 52. Furthermore, the height of the load-supporting beam 16 can be adjusted while the sawhorse 10 is supporting a load. In this example, the handle 52 is removable and the rod tip from which the handle 52 is removed can be used upon by a drill to serve as the actuator.

In this example, a high-stopper 56 is used on the rod 46, between the first connector 42 and second connector 44. The high-stopper 56 limits how close the first connector 42 and second connector 44 can be moved towards one another by providing opposite surfaces for abutting thereagainst, and thereby limits how high the beam 16 can be raised. A low-stopper 58 is used on the rod 46 between the first vertically extendible member 18 and the second vertically extendible member 20 to limit how low the beam 16 can be lowered. A ruler 60 having an upper end fixed to the load-supporting beam 16 extends downwardly therefrom into a vertically-oriented slot 62 through the body 12 of the sawhorse 10. The ruler 60 can be used to determine at which precise height the load-supporting beam 16 is adjusted. This can ease the relative adjustments of two sawhorses.

This arrangement provides an adjustable-height sawhorse which can lock into a precise position in which it is left by the actuator 52, i.e. weight of a work piece applied on the beam 16 does not cause the rod 46 to rotate or the height of the beam to vary.

FIG. 2 shows that the lower members 22, 24 of the first vertically extendible member 18 are channel shaped in this case, and have two transversally-opposite lateral flanges. The lower ends 26, 28 of the lower members 22, 24 are nested within a C-shaped base member 64, itself mounted to the body 12. The lower ends 26, 28 of the lower members 22, 24 are pivotally mounted to the base member 64 so as to be pivotable around respective and adjacent pivoting axes 70, 72. In this case, mating radial gears 66, 68 are provided on both flanges at the lower ends 26, 28 of both the first lower member 22 and the second lower member 24. The gears 66, 68 are toothed around the respective pivoting axes 70, 72. The gears 66, 68 are meshed with each other and thus maintain their meshed engagement when the lower members 22, 24 are pivoted. In this example, the upper members 34, 36 (FIG. 1) are mirror images of the lower members 22, 24, and are pivotally mounted to the beam 16 similarly to how the lower members 22, 24 are mounted to the sawhorse body 12. Furthermore, the second vertically extendible member 20 is similar to the first vertically extendible member 18.

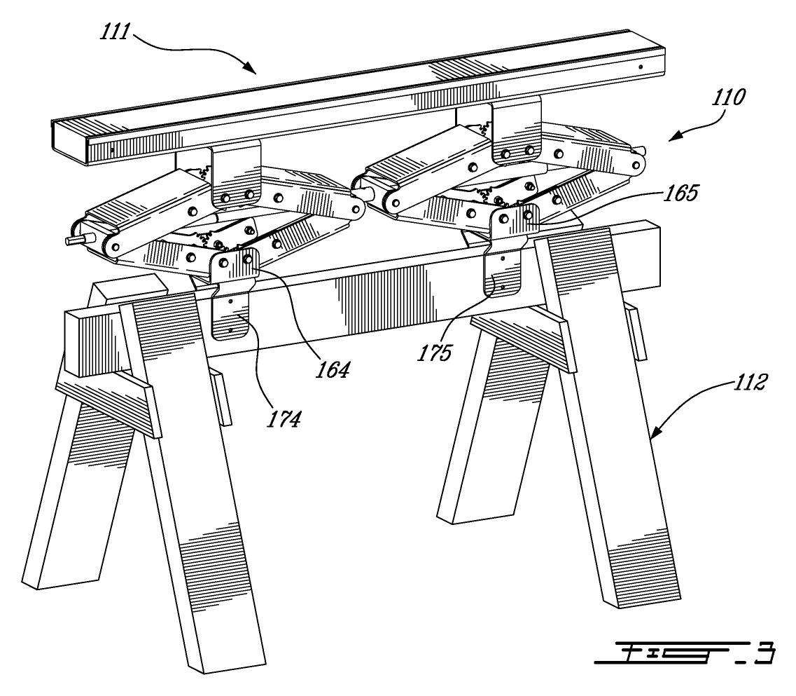

FIG. 3 shows a variant 110 of the sawhorse 10 shown in FIG. 1. The variant 110 (shown in the lowered position) is provided as an adjustable-height unit 111 which can assembled to a sawhorse body 1 12. The adjustable-height unit 111 can be sold separately from the sawhorse body 1 12. The adjustable-height unit 111 functions similarly to the sawhorse 10 of FIG. 1. The difference is that the C-shaped base members 164, 165 are provided with sawhorse body attachments 174, 175 which are designed to allow fastening the adjustable-height unit 111 securely to the sawhorse body 112. As many sawhorse body designs exist, the particular design of the attachments can vary accordingly in alternate embodiments.

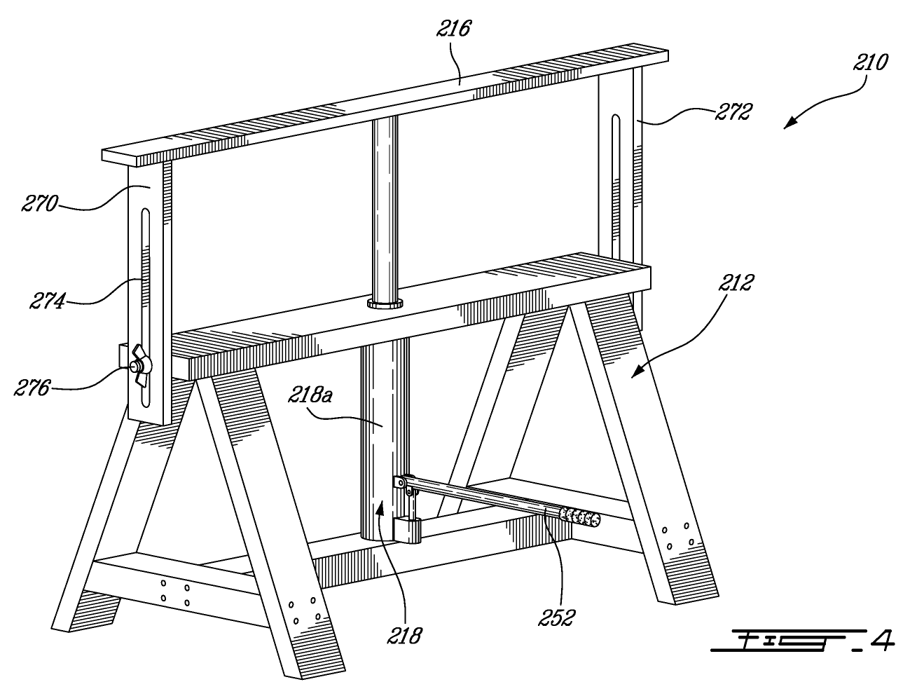

FIG. 4 shows another example of an improved sawhorse 210. The sawhorse 210 also has a body 212, and a load-supporting beam 216 which is vertically movable relative to the body 212 using a vertically extendible member 218. In this case, a single vertically extendible member 218 is used, and the vertically extendible member 218 is an hydraulic jack 218a. The actuator of the hydraulic jack 218a is a lever 252. The load-supporting beam 216 has guiding members 270, 272 extending downwardly therefrom at opposite ends. The guiding members 270, 272 each have a vertical groove 274 in which a guide pin 276 extending from the body 212 is slidingly engaged. As the load-supporting beam 216 is raised or lowered using the hydraulic jack 218a, the pins 276 on opposite sides of the body 212 slide within the grooves 274 of the corresponding guiding members 270, 272.

Another difference between the example of FIG. 1 and the example of FIG. 4 is the material used. In the example shown in FIG. 1, the sawhorse is made mainly of aluminum beams, whereas in the example shown in FIG. 4, the sawhorse is made mainly of wood boards. In alternate embodiments, these and other materials can be used.

It will thus be understood that in alternate embodiments, only one vertically extendible member can be used instead of two. Also, although the use of both two upper members and two lower members provides interesting features, alternate embodiments can use only two elongated members, i.e. a V-shape or upside-down V-shape configuration, by replacing the two upper members or the two lower members, respectively, by a slide mechanism. In still other alternate embodiments, an X-shape with an intermediate pivot point, similar to those known in scissor lifts, can be used as well. It will be understood that the pivoting axes of the reciprocal members can coincide, instead of being adjacent, in alternate embodiments. Any suitable reciprocation mechanism can be used as an equivalent to the rod and threaded bore arrangement described above to move the ends which are spaced from the pivot point away or towards one another to obtain the desired diminution or increase, respectively, in vertical height.

Further, in the example depicted in FIG. 1, using two vertically extendible members connected to a common rod provided extra stability to the load supporting beam. In alternate embodiments, instead of being actuatable by hand, the rod can be motor driven. Hence, the actuator for the vertically extendible member can alternately be a user interface for the motor such as a switch. In cases where it is desirable that the load-supporting beam be levelable relative to the body, a first vertically extendible member and a second vertically extendible member being driven by separate rods can be used, each rod having its own actuator. In the illustrated example, gears were used between the lower ends of the lower members and between the upper ends of the upper members to provide extra stability. In alternate embodiments, the gears can be replaced by equivalents thereof, or omitted. Meshed gears can be present at a single contact point of two reciprocal members instead of being present at four contact points of reciprocal members of each vertically-extendible member. Furthermore, a high-stopper is shown with the first vertically extendible member, it will be understood that it can be used with the second vertically extendible member or both, as well. The low stopper was used between the first vertically extendible members, though it will be understood that low stoppers can be used in relation with other connectors as well. The ruler is optional.

As can be seen therefore, the examples described above and illustrated are intended to be exemplary only. The scope of the invention(s) is intended to be determined solely by the appended claims.

What is claimed is:

1. A sawhorse comprising a body, a horizontal load-supporting beam, at least one vertically extendible member positioned between the load-supporting beam and the body and operable to adjust the vertical position of the load-supporting beam relative to the body, and an actuator to be acted upon for operating the at least one vertically extendible member.

2. The sawhorse of claim 1 wherein the vertically extendible member is configured and adapted for the vertical position of the load-supporting beam to be locked into place when a work piece applies weight on the load-supporting beam.

3. The sawhorse of claim 1 wherein the at least one vertically extendible member has two reciprocal elongated members each oppositely slanted from the vertical, and each having a first end opposite a second end, the first end of both elongated members being pivotally mounted about a transversal horizontal axis in a manner that the second ends of the elongated members are reciprocally pivotable about the first ends in a common vertical plane, and a reciprocation mechanism actuatable to move the second ends towards or away from the other, thereby raising or lowering the load-supporting beam, respectively.

4. The sawhorse of claim 1 wherein the at least one vertically extendible member includes: two lower members having respective lower ends each pivotally mounted to the body, and respective reciprocating upper ends; two upper members having respective adjacent upper ends each pivotally mounted to the load-supporting beam, and respective reciprocating lower ends each connected to a corresponding one of the reciprocating upper ends in a manner that the load-supporting beam is raised or lowered when the upper ends are moved towards or away from each other, respectively.

5. The sawhorse of claim 4 wherein a first connector and a second connector are each pivotally mounted to both a corresponding lower member upper end and a corresponding upper member lower end, each having a bore threaded oppositely to the bore of the other connector, and a rod having a first portion threaded to engage with the first connector bore, and a second portion threaded to engage with the second connector bore, the rod being threadingly engaged through both the first and the second connectors and being rotatable about its axis to move the upper ends towards or away from each other, thereby adjusting the vertical position of the load-supporting beam.

6. The sawhorse of claim 1 wherein the at least one vertically extendible member includes: two reciprocal lower members having respective adjacent lower ends each pivotally mounted to the body, and respective spaced apart upper ends; two reciprocal upper members having respective adjacent upper ends each pivotally mounted to the load-supporting beam, and respective spaced apart lower ends; a first and a second connectors, each connector being pivotally mounted to both a corresponding lower member upper end and a corresponding upper member lower end, and having a bore threaded oppositely to the bore of the other connector; and a rod having a first portion threaded to mate with the first connector, and a second portion threaded to mate with the second connector, the rod being threadingly engaged through both the first and the second connectors and being rotatable about its axis to change the spacing between the connectors, thereby changing the vertical position of the load-supporting beam.

7. The sawhorse of claim 3 wherein the reciprocal members are pivotally mounted about corresponding distinct adjacent axes.

8. The sawhorse of claim 7 wherein the reciprocal members each have a toothed gear meshed with a corresponding toothed gear of the adjacent reciprocal member for pivoting reciprocally at the pivotally mounted end.

9. The sawhorse of claim 3 wherein the reciprocal members are pivotable within a vertical plane coinciding with the load-supporting beam.

10. The sawhorse of claim 1 comprising two adjacent vertically extendible members.

11. The sawhorse of claim 5 comprising two longitudinally adjacent vertically extendible members interconnected by a common rod.

12. The sawhorse of claim 1 wherein the at least one vertically extendible member includes a piston and cylinder assembly.

13. The sawhorse of claim 12 further comprising at least one guiding member vertically mounted between the body and load-supporting beam, the guiding member having two relatively slidable components which slide relative to one another when the load-supporting beam is raised or lowered, thereby steadying the raising or lowering of the load-supporting beam by the vertically extendible member.

14. An adjustable-height unit for use on a sawhorse body, the adjustable-height unit comprising : a load-supporting beam, at least one extendible member connected to the load-supporting beam and having a sawhorse body attachment configured and adapted for fastening the adjustable-height unit to the sawhorse body opposite the load-supporting beam, the at least one extendible member having two reciprocal elongated members each oppositely slanted, and each having a first end opposite a second end, the first end of both elongated members being pivotally mounted about a transversal axis in a manner that the second ends of the elongated members are reciprocally pivotable about the first ends in a common plane, thereby raising or lowering the load-supporting beam, respectively, when in use fastened on a sawhorse body.

15. The adjustable-height unit of claim 14 further comprising a reciprocation mechanism actuatable to move the second ends towards or away from the other, thereby raising or lowering the load-supporting beam, respectively.

16. The sawhorse of claim 14 wherein the two reciprocal elongated members are first reciprocal elongated members, further comprising second reciprocal elongated members each oppositely slanted, and each having a first end opposite a second end, the first end of both second elongated members being pivotally mounted about a transversal axis in a manner that the second ends of the elongated members are reciprocally pivotable about the first ends in a common vertical plane, the first reciprocal elongated members being connected to and between the sawhorse body attachment and the second reciprocal elongated members and the second reciprocal elongated members being connected to and between the first reciprocal elongated members and the load-supporting beam in a manner that the second ends of the first elongated members and of the second elongated members are pivotable simultaneously to raise or lower the load-supporting beam.

17. The adjustable-height unit of claim 16 wherein the second ends of the first reciprocal elongated members are connected to the second ends of the second reciprocal elongated members.

18. The adjustable-height unit of claim 16 wherein a first connector and a second connector are each pivotally mounted to both a corresponding second end of the first reciprocal elongated members and to a corresponding second end of the second reciprocal elongated members, each one of the first connector and the second connector having a bore threaded oppositely to the bore of the other connector; and a rod having a first portion threaded to engage with the first connector bore and a second portion threaded to engage with the second connector bore is threadingly engaged through both the first connector and the second connector and rotatable about its axis to move the corresponding second ends towards or away from each other, thereby raising or lowering the load-supporting beam, respectively, when in use fastened on a sawhorse body.

19. The sawhorse of claim 14 wherein the reciprocal elongated members are pivotally mounted about corresponding, distinct, and adjacent axes, and wherein the first ends each have a toothed gear meshed with a corresponding toothed gear of the adjacent first end, for pivoting reciprocally at the pivotally mounted end.

20. A sawhorse comprising a body, a horizontal load-supporting beam, at least one vertically extendible member positioned between the load-supporting beam and the body and operable to adjust the vertical position of the load-supporting beam relative to the body, and an actuator to operate the at least one vertically extendible member, each of the at least one vertically extendible member having two reciprocal lower members having respective adjacent lower ends each pivotally mounted to the body, and respective spaced apart upper ends, two reciprocal upper members having respective adjacent upper ends each pivotally mounted to the load-supporting beam, and respective spaced apart lower ends, and a first and a second connectors, each connector being pivotally mounted to both a corresponding lower member upper end and a corresponding upper member lower end, and having a bore threaded oppositely to the bore of the other connector; and a rod having a first portion threaded to mate with the first connector, and a second portion threaded to mate with the second connector, the rod being threadingly engaged through both the first and the second connectors and being rotatable about its axis to adjust the spacing between the connectors, thereby adjusting the vertical position of the load-supporting beam.
